(19) United States
(12) Patent Application Publication
(10) Pub. No.: US 2021/0377309 A1
(43) Pub. Date: Dec. 2, 2021

(54) SYSTEM AND METHOD FOR ESTABLISHING SECURE SESSION WITH ONLINE DISAMBIGUATION DATA

(71) Applicants: HID Global CID SAS, Suresnes (FR); IdenTrust, Inc., San Francisco, CA (US)

(72) Inventors: Fabrice Jogand-Coulomb, Aix en Provence (FR); Cory R. Emmertson, Syracuse, UT (US)

(21) Appl. No.: 17/303,547

(22) Filed: Jun. 2, 2021

Related U.S. Application Data
(60) Provisional application No. 63/033,700, filed on Jun. 2, 2020.

(51) Int. Cl. H04L 29/06; H04L 9/08; H04L 9/30; G06K 7/10; H04L 9/32

(52) U.S. Cl. CPC H04L 63/168; H04L 9/088; H04L 9/3263; G06K 7/10366; H04L 9/3066

(57) ABSTRACT

Various systems and methods for securely sharing private information are described herein. A method of using disambiguation data to confirm the association with an online web service prior to engaging in a transaction, includes receiving, at an unresolved credential application executing on a mobile device, a disambiguation payload, wherein the disambiguation payload is purportedly associated with a web service, and wherein at least a portion of the disambiguation payload is signed with a cryptographic key associated with the web service; extracting a network location from the disambiguation payload; obtaining verification data from a resource at the network location to verify the web service; and validating the disambiguation payload using the verification data.

### PRIORITY APPLICATION

This application claims priority to U.S. Provisional Application Ser. No. 63/033,700, filed Jun. 2, 2020, the disclosure of which is incorporated herein in its entirety by reference.

### TECHNICAL FIELD

Embodiments described herein generally relate to electronic credential systems, and in particular, to establishing a secure session between an undetermined application and an online service in need of one or more identity credentials.

### BACKGROUND

Electronic identity documents may be stored in secure applications on a mobile device. Such an implementation is often referred to as a mobile identification (ID). Mobile IDs are replacing classical physical identification documents (e.g., passports or drivers' licenses) and bring many advantages to these types of documents. Mobile IDs may be encrypted to provide safeguards against losing data. Multiple credentials may be stored together in a single mobile ID application. Further, mobile IDs may provide additional ways to authenticate the identity stored thereon, providing law enforcement, commercial enterprises, banks, and others a more secure and robust mechanism to verify a person's identification.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating a credential system, according an embodiment;

FIG. 2 is a diagram illustrating a system to present a QR code containing disambiguation data that is acquired by an unresolved application of a user device and conditionally used by the unresolved application to connect to a web service, according to an embodiment;

FIG. 3 is a diagram illustrating a system where a user action provides disambiguation data to a credential application of a user device that is conditionally used by the credential application to connect to the web service, according to an embodiment;

FIG. 4 illustrates example user interfaces for obtaining permission to share credential data, according to an embodiment;

FIG. 5 is a message sequence diagram illustrating an online interaction, according to an embodiment;

FIG. 6 is a flowchart illustrating a method for checking disambiguation data at an intermediate app, according to an embodiment;

FIG. 7 is a flowchart illustrating a method 700 for validating disambiguation data, according to an embodiment;

FIG. 8 is a flowchart illustrating a method 800 for validating disambiguation data, according to an embodiment;

FIG. 9 is a flowchart illustrating a method 900 for validating disambiguation data, according to an embodiment;

FIG. 10 is a message sequence diagram illustrating various optional operations that may be used when confirming disambiguation payload during an online interaction, according to an embodiment;

FIG. 11 is a block diagram illustrating a framework for identity verification using a Web Authorization Application Program Interface (WebAuthn API), according to an embodiment; and

FIG. 12 is a block diagram illustrating an example machine upon which any one or more of the techniques (e.g., methodologies) discussed herein may perform, according to an embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Mobile identification (ID) systems are becoming more popular. Mobile IDs may be implemented with an application (“app”) on a smartphone or other mobile device. A credential app is able to enforce access control to protect the user's identity data and to handle different presentation protocols whether in person or over the Internet and according to a type of identity document. Mobile IDs provide other advantages over conventional physical IDs, such as remote provisioning, offline verification, distance verification, and per-attribute data privacy (also known as data minimization). A credential app is able to store multiple credentials (also referred to as identity documents), such as a driver's license, a passport, health insurance, a work identification, or a student ID for instance. Such credentials may be issued by governments, schools, health care systems, or the like.

To use a credential stored in a credential app, the user engages the mobile app to present credentials to a verifier device. The verifier device is able to interrogate the mobile device using various interfaces and obtain the credential information to verify. While use of a verifier device works well when the transaction is person-to-person (e.g., at a checkout lane or a police stop), users and businesses may also want to use the mobile ID to verify an identity document over the Internet. Online, the verifier device may be a system of one or more computers, databases, cloud compute resources, or other components that may be used together to perform verification of credential information.

In an example use case, the user wants to open a bank account and is interacting with the bank through a browser or application. The banking website or application may request that the user validate their identity. To do so, the banking website or application provides a quick response (QR) code in the website or application interface. The QR may be displayed using a separate device and then scanned using a credential app on the user's device (e.g., a mobile device), or the QR code may be included in a web page displayed on the user's device and the user clicks or otherwise selects the QR code. The scanning or selecting causes credential information to be transmitted from the credential app to the bank. In this way, the banking web server or other backend server is acting as the verifier device.

An issue with this example is that the credential app does not know prior to scanning the QR code where to provide the credential information for the bank web server to receive it. Conversely, the banking web server does not know which credential app the user is using and therefore, does not now which app is going to establish a connection. The bank's backend server uniform resource locator (URL) is provided in the QR code. However, the credential app does not know whether to trust the URL as this may be a malicious web service or a phishing attempt to spoof the credential app and obtain sensitive information. This is a new challenge, quite different from classical QR scan solutions where the QR data is aimed to a specific application and more importantly, the application already knows where to navigate to consume the QR data, such as with a hardcoded network address in the application. Here, web service prepares a QR for a credential app typically independent from the web service and the credential app receives the URL to connect to consume the QR data from the QR data.

Because the credential app is independent from the web service, there is a need to make sure the QR is associated with the web service to share the credentials with and that the web service is where the end user intends to share his/her credentials. TLS security protocol ensures the name of a web site contained in a URL actually belongs to the web service the communication has been established with. However, this is not enough to ensure the URL is coming from the intended site. In this situation and others like it, there is a need to go beyond confirmation of the authenticity of the service (typically provided by TLS session) and for the service to provide information to the credential app in addition to where to connect so that the credential app is able to confirm the link between the service and the received information (in particular where to connect) before providing credential information. Before validating the link between connection data service, the provided information is deemed to have an ambiguous origin. The information provides disambiguation data to allow the credential app to resolve the origin of the information and ensure it matches the web service with which credential information should be shared.

The present disclosure describes an improved credential system that provides a process to confirm and secure the association between a web service and a URL to transmit credential information to prior to transmitting. Additional features are discussed below.

### System Overview

Identity credentials (e.g., electronic documents, cards, etc.) include information such as a first and last name, a date of birth, an address, etc. In the digital world, each piece of information is a data element and these data elements are combined into a package that is issued to a target user. Having a digital credential provides several advantages. Information and documentation are easy to access. Digital credentials are typically signed for integrity and authenticity; therefore, more immune to counterfeiting and corruption than conventional credentials.

Some terms are provided here for common reference. It is understood that these terms are non-limiting and that other terms, phrases, or descriptions of operations, components, or devices in the systems and methods described may be used.

Package—a Package is a collection of name:value pairs of data, which are referred to as data elements. The name of the data pair may be referred to as (or associated to) a Tag, Field, or Description. A Package may include metadata about the Package, such as a Package Hash, Package Signature, Package Expiration, or the like.

Identity Credential—an Identity Credential is a collection of data elements issued as one or more packages. An aggregated Identity Credential includes two or more packages. Data elements in a package may be included by referencing a data element in another package. A data element reference may retain the confidence level of the original referenced data element. An Identity Credential may include metadata describing the issuer of the credential, expiration or validity dates, or other information about the Identity Credential.

Issuer—an Issuer is a person, entity, service, or other platform that delivers and signs a Package. The Issuer may attest to the authenticity, validity, and correctness of data contained in the Package. The Issuer may sign the Package or sign individual data in the Package. The Issuer may be an Original Issuer, which is an Issuer that created the data, or a Re-Issuer, which is one that reuses the Original Issuer's data and either reference or duplicate such data in the issued package. An Issuer or Re-issuer may issue a Package as an Identity Credential.

Holder—a Holder is a person who is the legitimate owner of the information in the package or credential. For an identity package, the Holder matches with the identity information.

Holder device—the device where the Holder stores the received package. The Holder device may be any type of computer device, such as a mobile phone, smartphone, personal information device, wearable device, laptop, tablet, hybrid machine, or the like. The Holder device may be known as a user device, where the user is the Holder. The Holder device may run a credential app where such data are managed during presentation to a Verifier. The Holder may have an application (or “App”) associated with it. A credential app is an application that is stored, executing, or otherwise linked to the Holder. The credential app may be a low-level application, such as a Basic Input Output System (BIOS) or other firmware, a system-level application (e.g., an operating system or a component of an operating system), a user-level application (e.g., an installed application on the Holder), or a remote application (e.g., a web-based application executing via a browser on the Holder). The credential app may also be referred to as a mobile ID app.

Verifier—a Verifier is a person or online service that operates or provides a Verifier device to verify data in a Package or Identity Credential on a Holder device. A Verifier device is the device running the verification application. A verifier service is the web service running the verification process. The verifier device may obtain an Identity Credential from a Holder device, for example at a point-of-sale during a commercial transaction, and then validate the data. The Verifier device may use an app or other hardware on the Verifier device to interrogate the Holder device or otherwise obtain the credential information. Other forms of validation may be used, such as by analyzing data signatures, analyzing a blockchain, or the like. A Verifier device may be an online system of devices, such as a web server, database server, transaction server, and the like. A Verifier device may verify the authenticity or validity of an Identity Credential. The Holder device and Verifier device may authenticate to one another before passing data.

Data that is provided by an Issuer may be signed by the Issuer. In some cases, data may be signed by the Holder device or a credential app. Metadata that describes the data may be stored in the Package or Identity Credential and used to attest to the authenticity or validity of the data.

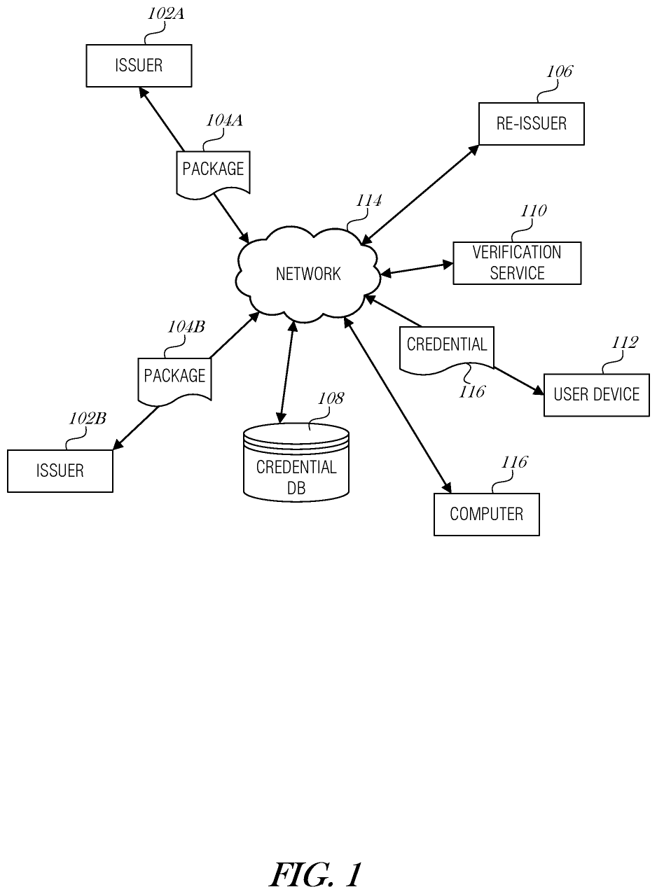

FIG. 1 is a block diagram illustrating a credential system 100, according an embodiment. The credential system 100 includes a first original issuer 102A and a second original issuer 102B (collectively referred to as 102) that issue core packages 104A, 104B (collectively referred to as 104). The core packages 104 include tags and values that are generated by the original issuers 102. The credential system 100 also includes re-issuers 106A, 106B (collectively referred to as 106) that compile data from one or more issuers (or re-issuers) in the credential system 100 and re-issue aggregated credentials with contents from two or more packages.

The re-issuer 106 may also add its own data to the aggregate credential by issuing its own package and consolidating the package with data from packages of other issuers 102. The re-issuer 106 may sign its own package, portions of its own package, or the aggregated credential.

A credential database 108 may be used to store packages and other data from one or more issuers 102 or re-issuers 106. The credential database 108 may use a relational database management system (RDBMS) to organize the package information into tables. The credential database 108 may be queried by various entities or users, such as a re-issuer 106, a verification service 110, or a user at a user device 112. A re-issuer 106 may query the credential database 108 to obtain original package information to populate an aggregated credential. The credential database 108 may be implemented on one or more servers. The credential database 108 may be owned or operated by a credential issuing entity. In some embodiments, issuers access the credential database 108 as part of a service.

The various components of the credential system 100 may communicate over one or more networks 114, which may include any known type of network that facilitates machine-to-machine communications. The network 114 may use the same communication protocols or different protocols without departing from the scope of the present disclosure. The network 114 may include wired or wireless communication technologies. The Internet is an example of a communication network that constitutes an Internet Protocol (IP) network consisting of many computers, computing networks, and other communication devices located all over the world, which are connected through many telephone systems and other means. Other examples of a communication networks include, without limitation, a Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over Internet Protocol (VoIP) network, a cellular network, and any other type of packet-switched or circuit-switched network known in the art. In addition, it can be appreciated that the communication network 114 need not be limited to any one network type, and instead may be comprised of several different networks or network types. Moreover, the network 114 may include a number of different communication media such as coaxial cable, copper cable/wire, fiber-optic cable, antennas for transmitting/receiving wireless messages, and combinations thereof.

The user device 112 may be of any type of compute device. The user device 112 is typically portable in nature, and may take the form of a cellular phone, mobile device, smart phone, personal digital assistant, laptop, tablet, wearable device, portable credential card, key fob, or the like. It should be appreciated that the verification service 110 may be provided by a personal computer, desktop computer, kiosk, payment terminal, beacon, web server, database server, service platform, or the like.

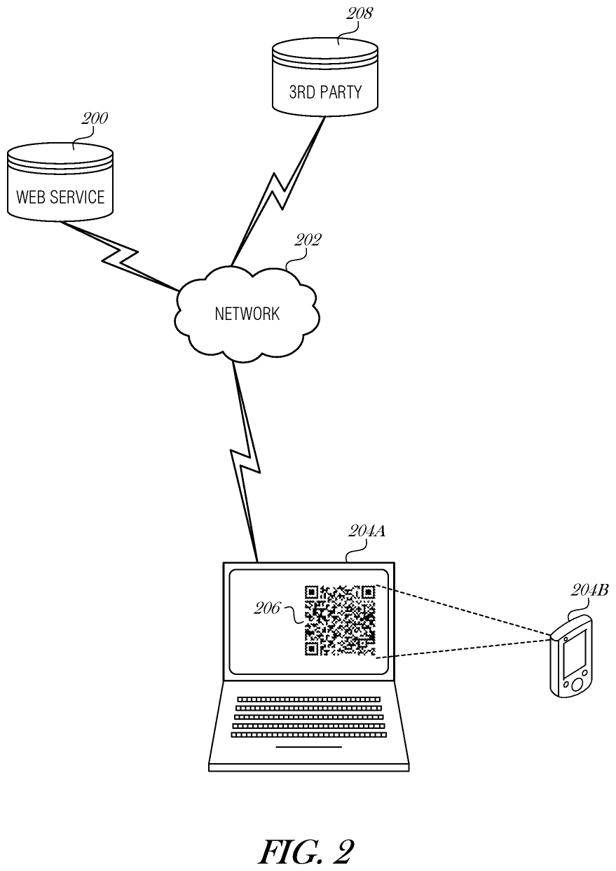

A user may be interacting with verification service 110 using a desktop computer 116. This is illustrated in FIG. 2. For instance, the user may be accessing an online banking system through a web browser. During a transaction, the user may be asked to present a credential 116 or part of a credential 116 to the verification service 110. The way this may be requested is through the use of a QR code. A QR code is displayed in the web page and the user is requested to scan the QR code with the user device 112. The user then may scan the QR code with the user device 112. Based on further operations described herein, the user device 112 may then connect to the verification service 110 and engage with the verification service 110. Engaging may include a process of authenticating the user device 112 or credential app executing on the user device 112 and the verification service 110 to one another. After the credential app on user device 112 and verification service 110 engage, the user may consent to share the credential 116 or a portion thereof. The verification service 110 may validate the credential 116 by checking the signature of the issuer 102 or re-issuer 106, or accessing from credential database 108 referenced by the credential app. The credential 116 may be stored on the user device 112 and shared with the verification service 110. Alternatively, the credential app may provide a token in a URL for the verifier to obtain the credentials from an issuer database instead of user device 112. The user is then able to continue with the transaction on the web page using the computer 116.

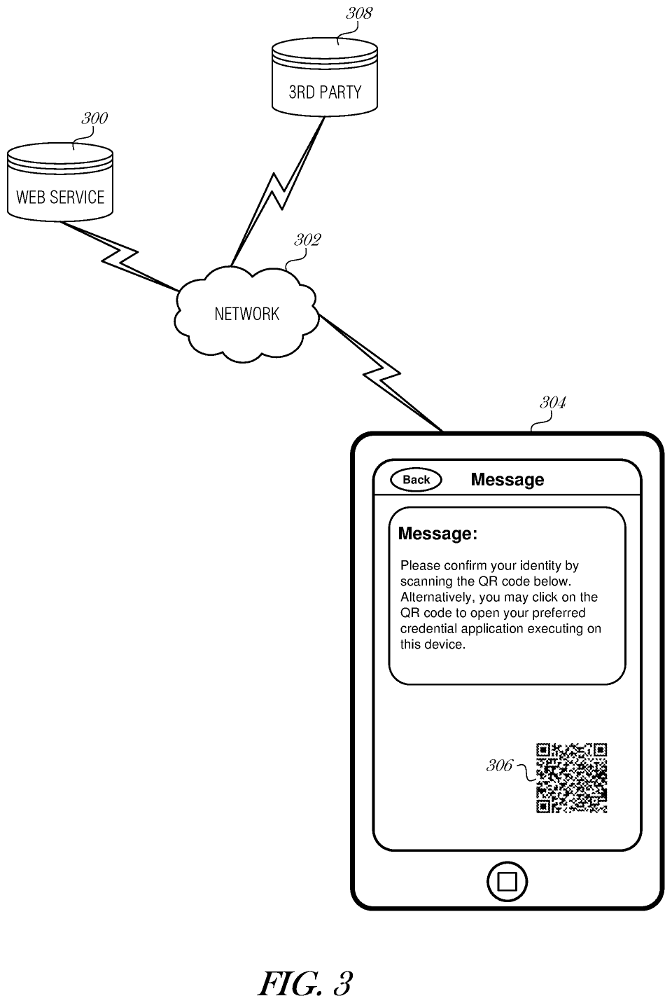

Alternatively, the user may be conducting an online transaction with a browser executing on the user device 112. This is illustrated in FIG. 3. In this case, it is not convenient for the user device 112 to scan the QR code that is displayed. Instead, active content may be used, such that when the user clicks or activates the active content, information is passed from application to application (e.g., browser to credential app) on the user device 112. As the backend system doesn't know where the “credential app” resides, the active content may be represented by the QR code thus allowing both type of actions. The active content may be implemented using deep links, scripting, plugins, application-to-application messaging, or other technologies. In an embodiment, the contents of the QR code presented as a clickable image is a hyperlink whose URL is the same content as the QR code. When the user clicks on the QR code, the hyperlink information is used to send the contents of the QR code to the associated app which could be the credential app or a broker service (or browser extension) on user device 112 that passes the information to the preferred (e.g., a default) credential app. If more than one credential app can be associated with the active content, the user may select a credential app to use.

FIG. 2 is a diagram illustrating a system to use a QR code to disambiguate a relationship between an online service and an unresolved application selected by a user, according to an embodiment. A server 200 is configured, adapted, or programmed to provide an online service. The service may be provided over a network 202 to one or more user devices 204, such as computer 204A or mobile phone 204B. The network 202 may be of any type of network as described herein. The user devices 204 may take the form of a cellular phone, mobile device, smart phone, personal digital assistant, desktop computer, laptop, tablet, wearable device, or the like.

The mobile phone 204B has a credential app (e.g., mobile ID app) installed to manage credential information. When using the online service provided by the server 200, the user may be requested to present credential information. In order to submit it, the server 200 and the mobile phone 204B engage with one another to establish a trust relationship. In order to perform engagement, the server 200 encodes date in a QR code, which is read by the mobile phone 204B and the engagement is negotiated through back channels. An “unresolved application” in this context is one where the web service does not know, in advance, which credential app is going to connect to the web service.

In an embodiment, during a transaction, the server 200 may present a QR code 206 to the user of the computer 204A. The QR code 206 may be presented within a document, such as a web page. In an embodiment, the QR code 206 is delivered by the service hosted at server 200 that also delivered the web page. In another embodiment the web page delivered by web service 200 may reference content from 3^{rd} party 208 and 3^{rd} party 208 may deliver the QR code 206 and in some cases use this as an opportunity for phishing the user credentials.

The user scans the QR code 206 with a mobile device 204B. The mobile device 204 engages with the server 200 using information encoded in the QR code 206. After engaging with the server 200, the mobile device 204 may present a confirmation interface to the user, where the user may select which identify information to share with the server 200.

FIG. 3 is a diagram illustrating a system where a user action allows to disambiguate a relationship between an online service and an unresolved application selected by the user, according to an embodiment. Similar to the system illustrated in FIG. 2, a server 300 is configured, adapted, or programmed to provide an online service, which is implemented over a network 302. In this implementation, the server 300 serves a document (e.g., a web page) to the intermediate app (e.g., Internet browser) on a mobile device 304. The document may include content from a third party 308. The mobile device 304 has stored on it a credential app. In an embodiment, the QR code 306 is delivered by the service hosted at server 300 that also delivered the web page. In another embodiment the web page delivered by web service 300 may reference content from third party 308 and third party 308 may deliver the QR code 306 and in some cases use this as an opportunity for phishing the user credentials.

In this situation, it is not convenient to use the mobile device 304 to scan the QR code. Instead, the QR code may be hyperlinked such that when the user activates it (e.g., clicks on the QR code hyperlink), information and control is passed to the credential app executing on the mobile device 304. For example, the hyperlink information is used to send the contents of the QR code to the associated app which could be the credential app or a broker service (or browser extension) on user device 304 that passes the information to the preferred credential app. In various implementations, the hyperlinked QR code may commence an application-to-application communication session to transmit data to the credential app. The hyperlink may include some or all of the same data that is encoded in the QR code. The hyperlink may include additional data, in some cases.

The payload encoded in the QR and the URL used in the hyperlink may be identical. A QR code can typically store more data than allowed by web browsers for maximum URL lengths. For the best compatibility, the size of the URL may be limited to 2000 characters, which is less than typical QR code can store. Consequently, in an embodiment, to maximize the browser options the payload shall not exceed the smallest size of the considered options. Using this limit, the same payload can be used indifferently for all browsers.

In an embodiment, the URL redirects to an app broker that can redirect the URL data to a default app or a user-selected app. For instance, in an embodiment, the app broker may be implemented as an operating system service, allowing application-to-application communication. In another embodiment, the app broker is built into the web browser app. When a URL with an app designation is activated, the app broker may intercept the activation and redirect the data in the URL to the target app. In another embodiment, the clickable engagement is resolved using an Application Program Interface (API) supported by the Intermediate Application similarly to APIs available for Web Authorization (e.g., WebAuthn API) or other framework, such as Security Assertion Markup Language (SAML) framework. A framework using WebAuthn for identity credential information is described elsewhere herein.

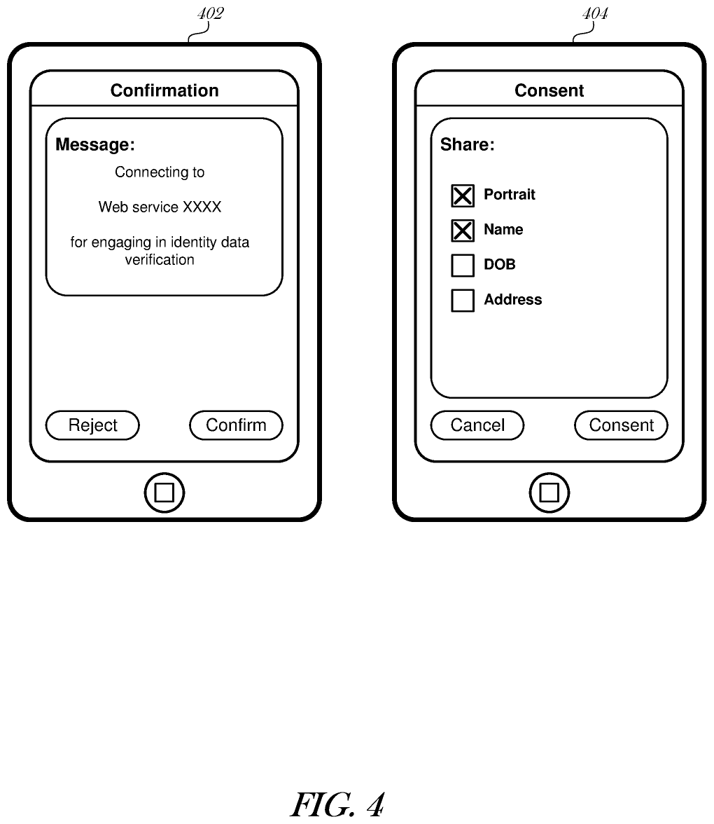

FIG. 4 illustrates example user interfaces for obtaining permission to share credential data, according to an embodiment. The user interfaces may include a confirmation interface 402 to allow the user to confirm that they want to connect to a service identified in the confirmation interface 402. The confirmation could take place at different stages of the connection to the web site from the URL from the disambiguation payload: before the connection to confirm the web site to engage to, during the establishment of TLS connection to confirm the web site leveraging the TLS certificate information and after using the public key of the TLS certificate to verify the signature of the disambiguation payload, once the communication is established and after receiving information from the connected site to verify the signature of the disambiguation payload. This gives the user assurances that the session is legitimate. If the user confirms that the service is one that is recognized, then a consent interface 404 is presented. The consent interface 404 may include one or more data elements of one or more credentials that the user may select from to share. The credential information that is selected to be shared is transmitted to the server (e.g., server 200 or server 300).

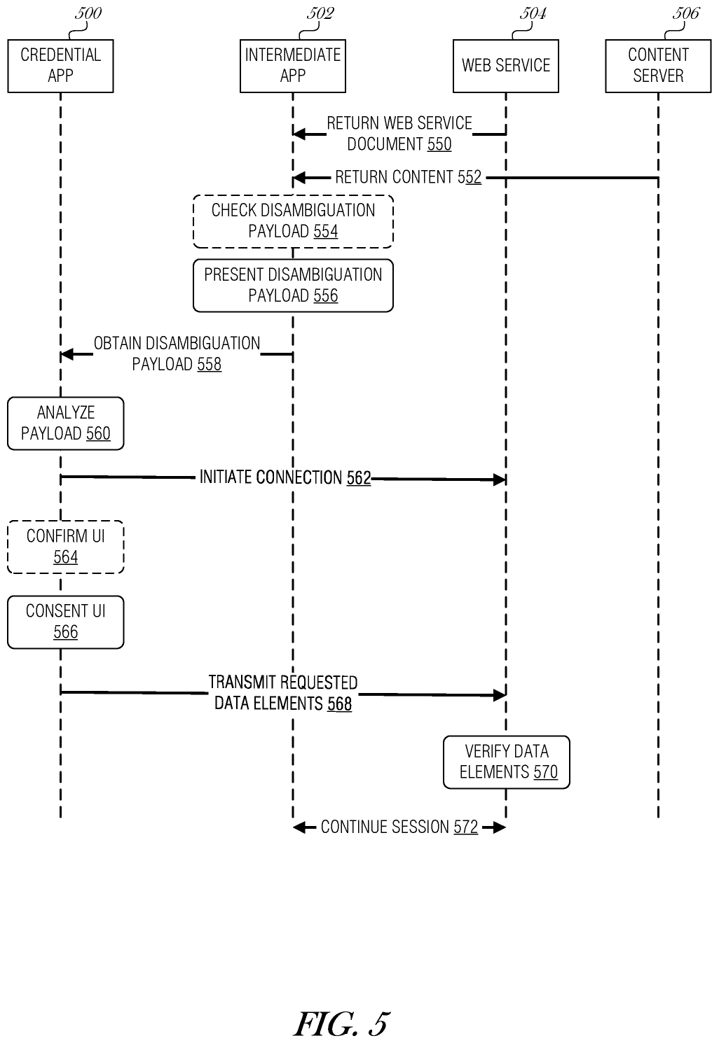

FIG. 5 is a message sequence diagram illustrating an online interaction, according to an embodiment. While the various processes will be described in accordance with illustrative steps performed in a particular order, it should be appreciated that embodiments of the present disclosure are not so limited and that any of the process steps depicted and described herein can be performed in any order or in parallel with one another.

The online interaction is between a credential app 500, an intermediate app 502, a web service 504, and a content server 506, which may be from a party other than web service 504. Using the intermediate app 502, a user is able to conduct online transactions. The intermediate app 502 may be a web browser or other application that incorporates Internet browsing capabilities. Example online transactions include, but are not limited to banking, shopping, real estate rentals or purchases, vehicle rentals, auction services, airline reservation or check in, or the like.

A user may use the intermediate app 502 to interact with the web service 504 in an online transaction. During a session, a web service document is returned (operation 550) by the web service 504. The web service document may be one of many types of documents, such as those in hypertext markup language (HTML) format and corresponding technologies. The web service document may reference content from other services, such as content server 506, which are received by the intermediate app 502 (operation 552) as part of the process to present the document from web service 504.

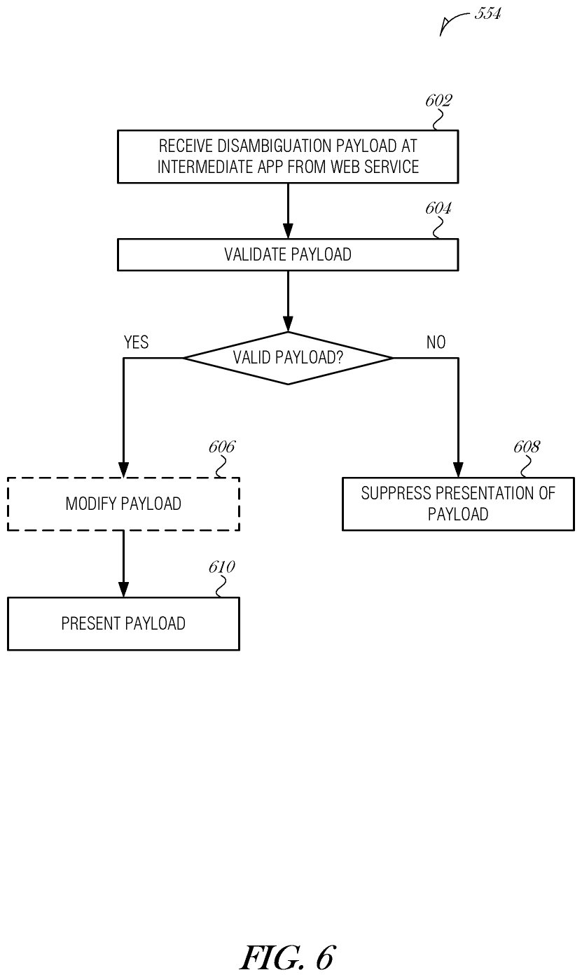

Part of the information received by the intermediate App 502 is the disambiguation payload which is optionally checked (optional operation 554) before presenting it to the user. The check may be performed within the intermediate app 502, an extension or plugin to the intermediate app 502, or a companion application executing on the same device as the intermediate app 502. Details of an example implementation are discussed further in FIG. 6 below.

The intermediate app 502 presents the disambiguation payload (operation 556). The disambiguation payload may be presented as an image representing a QR code. Optionally, the disambiguation payload may be encapsulated in an hyperlink associated with a URL and presented as active content (e.g., a hyperlink, active user interface scripting element, or the like), such that when a user activates the hyperlink (e.g., click), the intermediate app 502 may either navigate to the network location encoded in the URL or recognize the URL as associated with an application or service on the same computing device and accordingly provide the URL to the associated application.

The user may scan the QR code with their mobile device to obtain the disambiguation payload (operation 558). In an implementation, the user is able to open the credential app, enter an image capture mode in the credential app, and capture an image of the QR code with a camera in the mobile device.

Alternatively, the user may be conducting the online transaction with a computer that has the credential app installed on it, as in this case it isn't convenient to scan the QR code with the same computer. The user may then do an action such as clicking the QR code or otherwise activate it, while it is presented in the intermediate app 502. The clicking or other action initiates a communication with the credential app 500, where at operation 558, the intermediate app 502 is able to transfer the contents of the QR code to the credential app 500.

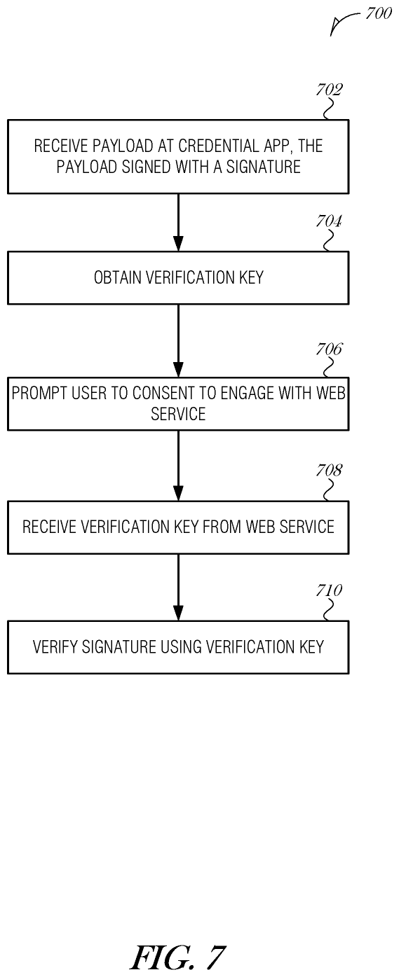

At operation 560, the credential app 500 analyzes the disambiguation data provided from the QR code or from the active content (e.g., URL). The disambiguation data is parsed to get the information to connect to. Then, depending on the embodiment, before, during or after operation 562, the credential app 500 may verify the signature to confirm that the data from the QR code is from the web service 504. The credential app 500 may initiate a connection with the web service 504 to receive the information to validate the payload (operation 562). Details of example implementations are discussed further below in FIGS. 7-9.

After the disambiguation data from the web service is authenticated, the user is assured that the web service 504 is associated with the disambiguation data and authenticity of the web service can be further confirmed using a typical TLS protocol. A confirmation user interface may be presented to the user (operation 564) to confirm that the user wishes to interact with the web service 504. Depending on the embodiment, such confirmation may take place before the validating the disambiguation data or after. An example of the confirmation dialog is in FIG. 4, element 402. The confirmation user interface may use information obtained when connecting with the web service 504 (in operation 562). For instance, during the connection, the web service may be identified during a Transport Layer Security (TLS) handshake. A TLS handshake is the process that kicks off a communication session that uses TLS encryption. During a TLS handshake, the two communicating sides exchange messages to acknowledge each other, verify each other, establish the encryption algorithms they will use, and agree on session keys. This information may be used in the confirmation user interface to ensure that the user intended to engage with the service identified in the TLS certificate. The user may then share credential information with the web service 504 to continue the online transaction.

In the case where the request specifying the requested credential information wasn't part of the QR code or URL, the request is received at operation 565 then the user is presented with a consent user interface (operation 566), where the user is able to select which data elements to share with the web service 504. In the case where the request was part of the QR code or URL, operation 564 and 566 may take place together. The requested data elements may be presented with information showing the identity of the web service 504 and the user's confirmation may operate as consent. The selected data elements may be signed, encrypted, or packaged in various ways to protect their contents before transmitting to the web service (operation 568). The web service 504 acts as the verifier and verifies the data elements (operation 570). If the data elements are valid, the session continues (operation 572).

### Operations

Turning to FIGS. 6-9, the methods described in these figures each describe ways to validate the payload of the QR code (i.e., disambiguation data). The payload may be obtained through various mechanisms, as described above. For instance, the QR code may be optically scanned with an image capture device, the resulting image data provided to the credential app for decoding and verification. As another example, the contents of the QR code may be transmitted using a URL or other link. The content of the payload may vary according to the method described. The methods of FIGS. 6-9 ensure that the payload matches with the web service to continue the transaction with. The mobile holder may still have to confirm the web service is the one expected.

The disambiguation payload includes a location of the web service that is requesting the credential information, such as identification data. The location may be in the form of a uniform resource identifier (URI) or URL. The disambiguation payload may also include a digital signature. For example, an Elliptic-curve cryptograph (ECC) format with 512 bit key results in a signature whose size is typically about 80 bytes of storage this easy to fit in addition to the necessary information within a URL or QR. The disambiguation payload may also include other data depending on the exact mechanism used to validate the service's provenance.

Each of the methods described in FIGS. 6-9 may be used independently or combined together in various combinations.

FIG. 6 is a flowchart illustrating a method 554 for checking disambiguation data at an intermediate app, according to an embodiment. An intermediate app (e.g., a web browser) may validate disambiguation data before presenting it to the user. At 602, the payload is received at the intermediate app from web service. The intermediate app may store the payload in memory as it constructed the document to be presented to the user. The intermediate app then validates the payload (operation 604).

For example, the intermediate app may validate the payload by checking that the source is not external to the web service, that the URL is matching with the QR data, or by verifying the signature of the QR data using information from the web service or any combinations thereof. In another example, the intermediate app may check that the payload comes from the same location as the connected web site before making the payload available to the mobile app. For instance, the intermediate app may check that the reference for the content doesn't specify another domain for downloading the payload, or may check that the reference for the content isn't provided within a structure used to embed content (e.g., Embed, iFrame, object tags, etc.). If the payload is loaded from a script, the intermediate app may check that the script comes from the same location as the connected website.

If the payload is validated, the payload may optionally be modified by the intermediate app before presentation (operation 606). For instance, in an embodiment, the intermediate app may sign the payload to mean it meets some or all of the verification criteria such that when the credential app obtains the payload, the credential app is able to confirm that the payload was first verified by the intermediate app. In another embodiment, the intermediate app may add a Transport Layer Security (TLS) or Secure Sockets Layer (SSL) session key of the session between the intermediate app and the web service to the payload. The credential app may then use the session key data to verify later requests received from the web service. TLS verification may be used with other types of verification techniques discussed herein.

At operation 608, the payload is presented to the user. For instance, the intermediate app may present the QR code in a web page for the user to consume. The intermediate app may also hyperlink the image of the QR code, such that when the user clicks on the hyperlink, an application-to-application communication is generated to pass the disambiguation data to the adequate credential app (undetermined from the web service).

If the payload is not valid, then the QR code is not presented in the document (operation 610). An error code, warning icon, or other indicia may be presented in or near the location where the QR code would be presented to alert the user that an exception has occurred.

FIG. 7 is a flowchart illustrating a method 700 for the unresolved app to validate the disambiguation data, according to an embodiment. At 702, the payload data is received by the credential app, where the payload data is associated with a web service. The payload data may be encoded in a QR code or in a URL. Some or all of the payload data is signed by the web service.

In the embodiments where the intermediate application updates the payload, the credential app may verify that the update from the intermediate app is supported by a trusted authority, i.e., the certificate added to the signature is from a trusted authority. Accordingly, confirmation may be limited to consent sharing data and connecting to the web service may start without consent.

At 704, the payload data is parsed, and a target URI is identified. The URI, which may be a URL, is the location of the web service to share credentials with and where to get the signature verification information (verification key). The verification key is used to verify the signature of the web service. Such key could be extracted from the TLS certificate or received once communication has been established. The URI may be split into two portions: the base URI and session information. Alternatively, the URI may be a typical URL. In some embodiments where each payload is signed by a key specific to that verification session, the session data in the URI may be used by the web service to derive a session-specific signature verification key.

At 706, the user is optionally prompted to consent to the engagement with the web service. This may be similar to the confirmation user interface illustrated in FIG. 4 and discussed in operation 564 of FIG. 5. In an embodiment, the consent user interface is based on information passed in the URI. For example, the URI may contain information about the communication session and the consent could apply to both connected to the web site and approving the credentials to return. In another embodiment, there could be two steps: one to approve connection to the web service and the other to consent to the verification.

At 708, the credential app receives a signature verification key from the web service that allows it to confirm that the signature of the payload is correct. The credential app may then use the verification key to verify the signature of the disambiguation payload (operation 710).

The method 700 has several benefits including, the use of a verification key to validate the signature, which is relatively simple to implement. Further, the implementation discussed in FIG. 7 is Public Key Infrastructure (PKI) independent. This reduces the computation and complexity of the implementation. However, in order to implement the method 700, the credential app has to connect to the web service before it can fully validate the disambiguation payload. To address this potential security risk, additional methods are described herein.

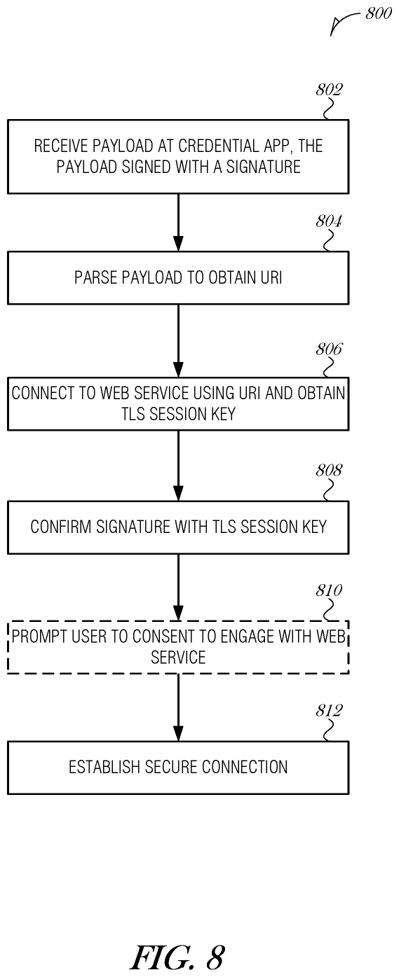

FIG. 8 is a flowchart illustrating a method 800 for validating disambiguation data, according to an embodiment. At 802, the payload data is received by the credential app, where the payload data is associated with a web service. The payload data may be encoded in a QR code or in a URL. Some or all of the payload data is signed by the web service. The signature used to sign the payload data is a private key paired with the TLS certificate from a TLS session.

At 804, the payload data is parsed, and a target URI is identified. The URI, which may be a URL, is the location of the web service. Obviously, that is also the location for the credential app to receive the TLS certificate whose public key can be used to verify the signature of the disambiguation data and confirm the association. At 806, the credential app initiates communication with the web service and obtains the TLS session key associated with the TLS certificate.

At 808, the mobile ID confirms the signature with the TLS session key. At 810, the signature of the disambiguation payload has been verified as valid and the user is optionally prompted to consent to proceed with communicating to the web service. This may be similar to the confirmation user interface illustrated in FIG. 4 and discussed in operation 564 of FIG. 5. The consent user interface is based on the TLS certificate.

At 812, once the connection is established and confirmed valid, the credential app may generate an ephemeral key to establish point-to-point encryption with the verifier at the web service. An ephemeral key is typically a single-use key for a single session or interaction. An ephemeral key may be a symmetric key or an asymmetric key (Public Key Infrastructure (PKI)). This ephemeral key is in addition to secure transport layers. The ephemeral key may be used with a web service public key to derive an encryption key.

In an embodiment, the payload data includes: 1) a URL used to receive the information to validate the (signature of the) payload data or a URL to which to return the response data, 2) a list of data elements that will be requested from the credential app, and 3) the web service signature. The signature may apply to a portion of the payload data, such as only to the URL used to validate the payload data and the list of data elements. The payload data may also include a signature of the intermediate app (e.g., if the browser were to analyze and validate the payload data before presenting the QR code).

In another embodiment, the payload data includes: 1) a URL used to receive the information to validate the signature of the payload data, 2) a list of data elements that will be requested from the credential app, 3) the web service signature, and 4) a public key. In this embodiment, the public key is used for communicating information from the credential app to the web service expected to have the matching private key.

In another embodiment, when implementing a clickable engagement mechanism, the payload data includes: 1) a URL used to connect to receive the information validate the signature of the payload data, 2) a list of data elements that will be requested from the credential app, 3) the web service signature, and 4) a TLS session key. In this embodiment, the TLS session key is of the communication session between the intermediate app and the web service. The TLS session key is used to sign the URL and the web service signature is used to sign part or all of the payload data

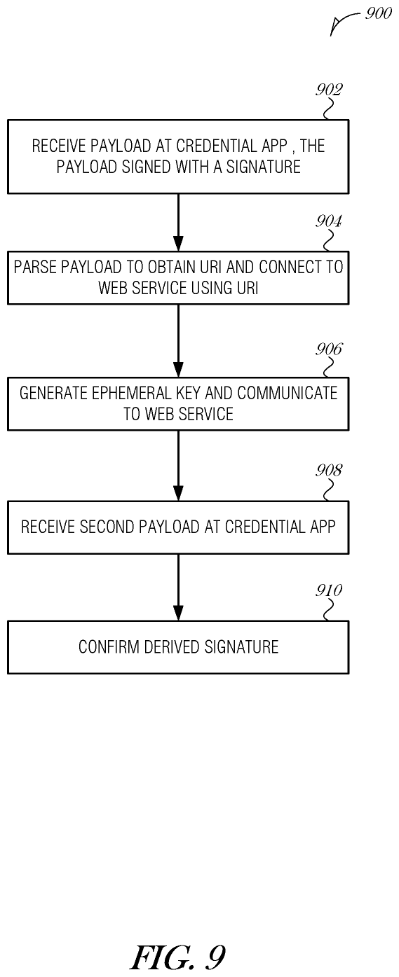

FIG. 9 is a flowchart illustrating a method 900 for validating disambiguation data, according to an embodiment. Similar to methods 700 and 800, the credential app is used to capture the disambiguation data (e.g., payload data). At 902, the payload data is received by the credential app, where the payload data is associated with a web service. The payload data may be encoded in a QR code. Some or all of the payload data is signed by the web service.

At 904, the credential app connects to the web service. This may be performed as in method 700 where a target URI is identified and used to connect to the web service.

At 906, the credential app generates an app ephemeral key and communicates the key to the web service. The app ephemeral key is a public key of a key pair. The web service will use the app ephemeral key to sign a portion of a second payload data that will be encoded in a second QR code. In particular, the web service generates its own PKI ephemeral key—a web service ephemeral key. The web service then derives a new key from both the public app ephemeral key and the web service's public ephemeral key. The new key is used to sign at least a portion of the second payload data.

The intermediate app that is displaying the QR code is automatically or manually operated to refresh the web page displaying the QR code. After the refresh, a different QR code is displayed that contains the second payload data (that which is signed by the derived key). The payload data includes the web service's ephemeral key, the payload encrypted with the key derived from both public ephemeral keys, and a list of requested identity data.

At 908, the second payload data is received by the credential app. As with the first payload data, the second payload data may be scanned with a QR code scanner. At 910, the second payload data is parsed, and the derived key is verified.

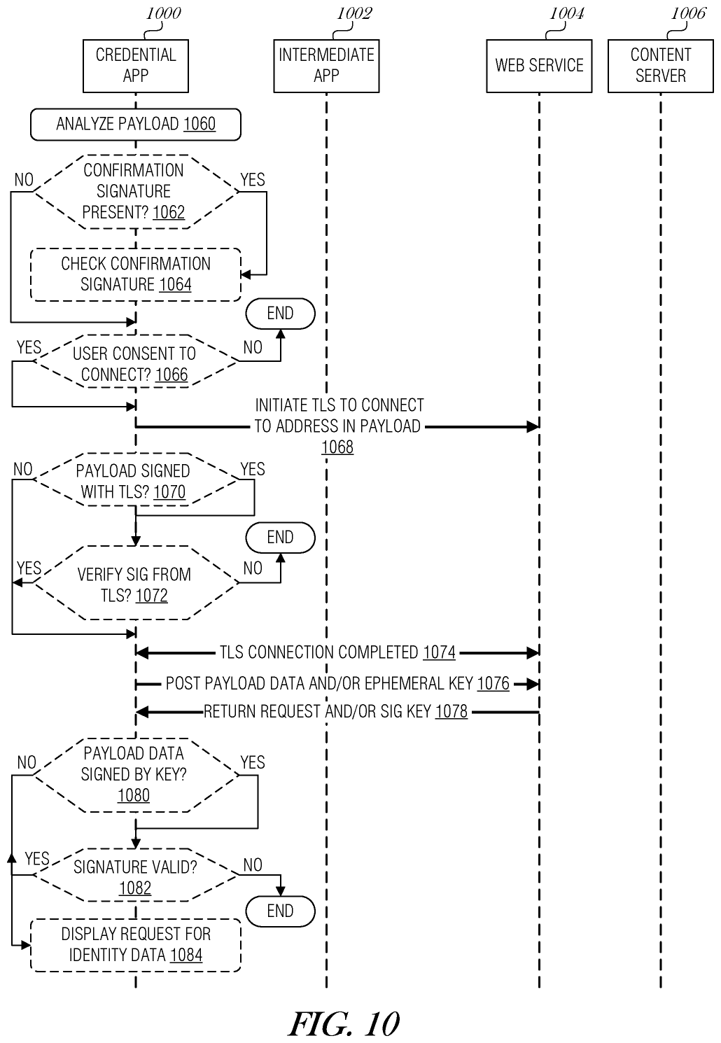

FIG. 10 is a message sequence diagram illustrating various optional operations that may be used when confirming disambiguation payload during an online interaction, according to an embodiment. While the various processes will be described in accordance with illustrative steps performed in a particular order, it should be appreciated that embodiments of the present disclosure are not so limited and that any of the process steps depicted and described herein can be performed in any order or in parallel with one another.

The online interaction is between a credential app 1000, an intermediate app 1002, a web service 1004, and a content server 1006. Using the intermediate app 1002, a user is able to conduct online transactions. The intermediate app 1002 may be a web browser or other application that incorporates Internet browsing capabilities. Example online transactions include, but are not limited to banking, shopping, real estate rentals or purchases, vehicle rentals, auction services, airline reservation or check in, or the like.

As described elsewhere in this document, a user may use the intermediate app 1002 to interact with the web service 1004 in an online transaction. During a session, a web service document is returned to the intermediate app 1002. The web service document may be one of many types of documents, such as those in hypertext markup language (HTML) format and corresponding technologies. The web service document may reference content from other services, such as content server 1006, which are fetched by the intermediate app 1002. The disambiguation data is encoded in a QR code or as part of a hyperlink, in various examples. The credential app 1000 obtains the payload data by either scanning the QR code or receiving data from an application programming interface or other communication interface.

At operation 1060, the credential app 1000 analyzes the disambiguation data received from scanning the QR code or from the active content (e.g., URL) leading to app-to-app communication. The credential app 1000 may check for the type and content of the disambiguation data. It may determine, for example, whether the disambiguation data has been confirmed by the intermediate app 1002 as coming from the connected web service (and not a 3^{rd} party) and validate the confirmation.

At 1062, it is determined whether there is a confirmation signature present in disambiguation data. If there is, then at 1064, the confirmation signature is validated. The confirmation may be provided by the intermediate app 1002, which may sign the disambiguation data with its signature. An example embodiment is discussed in FIG. 6, above.

At 1066, the credential app 1000 may prompt the user to consent to connect to the web service. The identification of the web service may be obtained from the TLS certificate. If the user declines to connect to the web service 1002, then the session ends. If the user consents to connect, then the session continues.

The user may be asked to confirm connection to the web site before starting any communication then at 1068, a TLS session is initiated to connect to the address in the payload data. The credential app 1000 receives a TLS certificate from the web service 1002 and relies on TLS protocol to confirm that this is the intended site.

At 1070, it is determined whether the payload is signed with the TLS public key. If it is, then at 1072, the public key from the TLS certificate is used to verify the signature. An example implementation is described in FIG. 8, above. If the signature is invalid, the session flow ends. Otherwise, the session continues.

At 1074, the TLS connection is completed and the credential app 1000 may share information from the payload (operation 1076) such as a session identifier when the session is not part of the URL and may share a public key that will be used to establish end-to-end encryption with the verifier application at the web service 1002 on top of the secure TLS channel. This is valuable as the verification service may run behind the web service front end and end-to-end encryption ensures better privacy of the transferred data.

In the case where the requested credentials was part of disambiguation data payload, then operation 1076 may be performed after optional operation 1084. In such an embodiment, operation and 1078 may not be necessary if the payload signature verification already occur.

At 1078, the web service 1002 returns the verifier request as well as the verifier public key. The web service 1002 may be the verifier or may act as the proxy to the verifier. The verifier request may be encrypted with a key derived from both the verifier private key and the credential app public key. The decryption key may be derived from both the credential app private key and the verifier public key (e.g., Diffie Helman key derivation). The web service 1002 may also return the key related to method 700.

At 1080, it is determined whether the payload is signed with a key from the web service. If it is, then it is determined whether the signature is valid (operation 1082). If the signature is invalid, then the session ends. If the signature is valid, then the payload is confirmed bound to the web service, and a request for identity data is displayed (operation 1084). The consent request may be preceded with a confirmation screen, such as one illustrated in FIG. 4. If user consent is not available, the session ends. If user consent is available, the credential app sends the response data. The response data may be encrypted with a derived key. It should be noted that operation 1084 may not be used when the request was previously provided to the credential app 1000 (e.g., in the payload). The user is then able to confidently share identity information with the web service 1004 knowing that the web service 1004 is bound to the QR code and its disambiguation data on the document where the QR code was displayed.

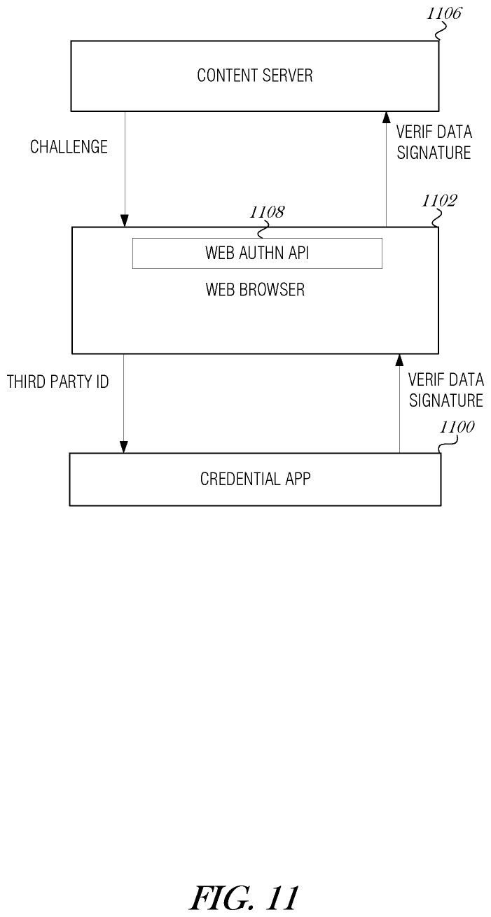

FIG. 11 is a block diagram illustrating a framework for identity verification using an API (e.g., a WebAuthn API). The credential app 1100 and the web browser 1102 may reside in the mobile device. The web browser 1102 interacts with the content server 1106 of the third party (e.g., the relying party) and the web browser 1102 may be an intermediate app. The web browser 1102 includes an API 1108 that also resides in the mobile device. The web page from the web service calls the API to request authentication. The API receives a challenge formatted to be recognized as a request for one or more credentials. When responding to the formatted challenge, the API returns the requested identity data (e.g., in the authenticatorassertionresponse from a WebAuthn API).

The format of the challenge from the content server 1106 may be recognizable by another party's code (which may be malicious) as an identity verification challenge that will return requested identity data elements. To provide additional security, the response of the credential application 1100 to the challenge may be expanded to include a list of requested credentials encrypted or otherwise protected with a signature of the identity data issuer.

The systems and methods described herein facilitate using an identify document as an identity credential. However, an issue that can arise is how to handle a change in the identity document without locking out users when the change occurs. An approach is to use to use identity data that remains unchanged between identity documents owned by a single person. For example, the credentials could be computed from “full name”, “date of birth”, “city of birth”, etc.

With data minimization, a mobile identity credential may contain information such as unique national identifier (e.g., a person's social security number) and this could be used instead of some other data elements subject to be changed (e.g., a person's name). The identity data elements could be hashed together to create a unique identifier. This unique identifier credential could be used along with biometrics to confirm that the information is provided under the control of the identity owner. Performing a match between the identity credential and biometric data can be performed on the mobile device or on the system backend.

The request for an identity credential could be for such a unique identifier credential. This would result in increased privacy because a hash of specified data elements is returned instead of the actual data elements. The hash of identity elements could be combined with biometrics and the biometrics used to recover a signature key. Biometrics could be used to match with backend data or to recover a signature key using a biometric token and the biometric data. The signature key can be used to verify identity to respond to a challenge.

### Example System Components

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture

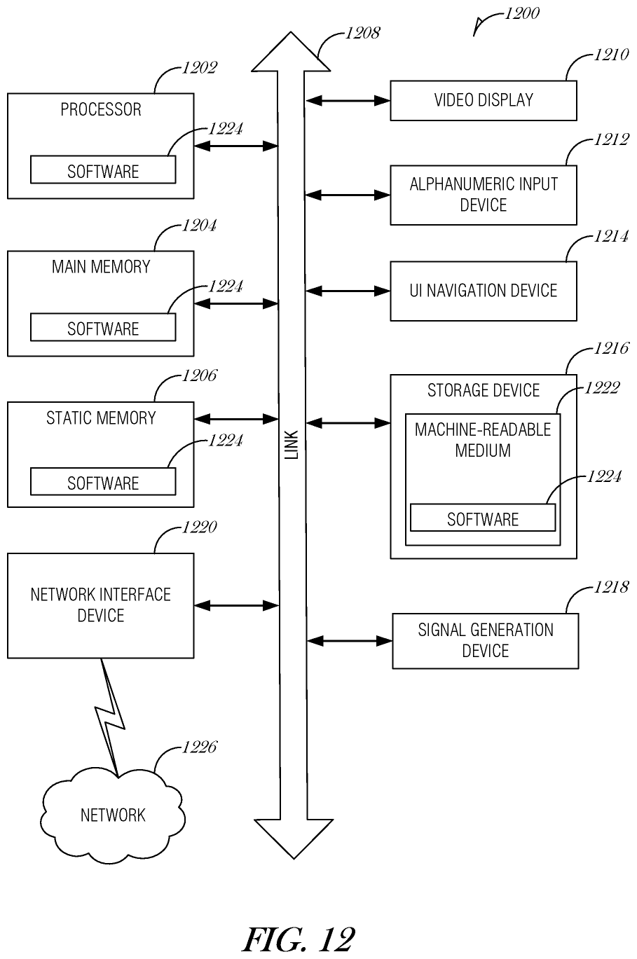

FIG. 12 is a block diagram illustrating a machine in the example form of a computer system 1200, within which a set or sequence of instructions may be executed to cause the machine to perform any one of the methodologies discussed herein, according to an embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a mobile device, a personal computer (PC), a tablet PC, a hybrid tablet, a personal digital assistant (PDA), a mobile telephone, a kiosk, a beacon, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 1200 includes at least one processor 1202 (e.g., a central processing unit (CPU), a graphics processing unit (GPU) or both, processor cores, compute nodes, etc.), a main memory 1204 and a static memory 1206, which communicate with each other via a link 1208 (e.g., bus). The computer system 1200 may further include a video display unit 1210, an alphanumeric input device 1212 (e.g., a keyboard), and a user interface (UI) navigation device 1214 (e.g., a mouse). In one embodiment, the video display unit 1210, input device 1212 and UI navigation device 1214 are incorporated into a touch screen display. The computer system 1200 may additionally include a storage device 1216 (e.g., a drive unit), a signal generation device 1218 (e.g., a speaker), a network interface device 1220, and one or more sensors (not shown), such as a global positioning system (GPS) sensor, compass, accelerometer, gyrometer, magnetometer, or other type of sensor.

The storage device 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204, static memory 1206, and/or within the processor 1202 during execution thereof by the computer system 1200, with the main memory 1204, static memory 1206, and the processor 1202 also constituting machine-readable media.

While the machine-readable medium 1222 is illustrated in an example embodiment to be a single medium, the term “machine-readable medium” may include a single medium or multiple media (e.g., a centralized or distributed database, and/or associated caches and servers) that store the one or more instructions 1224. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include nonvolatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1224 may further be transmitted or received over a communications network 1226 using a transmission medium via the network interface device 1220 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Description and Examples

Example 1 is a method of using disambiguation data to confirm the association with an online web service prior to engaging in a transaction with an unresolved application executing on a mobile device, comprising: receiving, at the unresolved application executing on a mobile device, a disambiguation payload, wherein the disambiguation payload is purportedly associated with a web service, and wherein at least a portion of the disambiguation payload is signed with a cryptographic key associated with the web service; extracting a network location from the disambiguation payload; obtaining verification data from a resource at the network location; and validating the disambiguation payload using the verification data.

In Example 2, the subject matter of Example 1 includes, wherein the signature is an Elliptic-curve cryptograph (ECC) signature.

In Example 3, the subject matter of Examples 1-2 includes, wherein the disambiguation payload is presented by an intermediate application for being consumed by the unresolved application.

In Example 4, the subject matter of Example 3 includes, wherein the intermediate application verifies the payload before making it available or presenting it in the document.

In Example 5, the subject matter of Example 4 includes, wherein to verify the disambiguation payload, the intermediate application analyzes a signature stored in the disambiguation payload.

In Example 6, the subject matter of Examples 1-5 includes, wherein receiving the disambiguation payload comprises: scanning a quick response (QR) code that is displayed on a computer screen; and decoding the QR code to obtain the disambiguation payload.

In Example 7, the subject matter of Examples 1-6 includes, wherein receiving the disambiguation payload comprises receiving the disambiguation payload from an intermediate application through an application-to-application communication mechanism.

In Example 8, the subject matter of Examples 1-7 includes, presenting a confirmation user interface to a user of the mobile device, the confirmation user interface to confirm that the user is to connect with the web service purportedly associated with the disambiguation payload.

In Example 9, the subject matter of Example 8 includes, wherein the confirmation user interface is presented after the TLS connection has been initiated and verification data has been received from the web service.

In Example 10, the subject matter of Examples 1-9 includes, presenting a consent user interface to a user of the mobile device, the consent user interface to obtain a selection of identity credential data elements that the user consents to share with the web service.

In Example 11, the subject matter of Example 10 includes, transmitting the selection of data elements from an identity document to provide the user's identity to the web service.

In Example 12, the subject matter of Examples 1-11 includes, wherein the verification data comprises a verification key used to verify the signature associated with the web service, wherein the key is part of the disambiguation payload.

In Example 13, the subject matter of Examples 1-12 includes, establishing a Transport Layer Security (TLS) session between the unresolved application and the web service; and obtaining a TLS certificate corresponding to the TLS session, wherein the verification data comprises the TLS session key.

In Example 14, the subject matter of Examples 1-13 includes, establishing a Transport Layer Security (TLS) session between the unresolved mobile application and the web service; and obtaining a TLS certificate corresponding to the TLS session, wherein the verification data comprising TLS certificate public key.

In Example 15, the subject matter of Examples 1-14 includes, establishing a Transport Layer Security (TLS) session between the unresolved application and the web service; and receiving from the web service the verification data.

In Example 16, the subject matter of Examples 13-15 includes, generating an ephemeral key; and transmitting the ephemeral key to the web service to establish point-to-point encryption independent from the established TLS transport.

In Example 17, the subject matter of Examples 1-16 includes, generating an ephemeral key; and transmitting the ephemeral key to the web service, the web service to generate a second disambiguation payload using the ephemeral key; wherein obtaining verification data comprises receiving the second disambiguation payload at the mobile identification application, and wherein validating the disambiguation payload comprises validating the second disambiguation payload using a corresponding ephemeral key.

Example 18 is a method of using disambiguation data to confirm the association with an online web service prior to engaging in a transaction, comprising: receiving, at an unresolved mobile application executing on a mobile device, a disambiguation payload, wherein the disambiguation payload is purportedly associated with a web service, and wherein at least a portion of the disambiguation payload is signed with a cryptographic key associated with the web service; extracting a network location from the disambiguation payload; obtaining verification data from a resource at the network location; and validating the disambiguation payload using the verification data.

Example 19 is a method of using disambiguation data to confirm an association between an online web service and an application, comprising: receiving, at the application executing on a mobile device, a disambiguation payload, wherein the disambiguation payload is purportedly associated with the online web service, and wherein a portion of the disambiguation payload is signed with a signature associated with the online web service; extracting a network location from the disambiguation payload; obtaining verification data from a resource at the network location; and validating the disambiguation payload using the verification data.

In Example 20, the subject matter of Example 19 includes, wherein the signature is an Elliptic-curve cryptograph (ECC) signature.

In Example 21, the subject matter of Examples 19-20 includes, wherein the disambiguation payload is embedded in a document presented by an intermediate application, and wherein the intermediate application verifies disambiguation payload before presenting it in the document.

In Example 22, the subject matter of Example 21 includes, wherein to verify the disambiguation payload, the intermediate application analyzes a signature stored in the disambiguation payload.

In Example 23, the subject matter of Examples 19-22 includes, wherein receiving the disambiguation payload comprises: scanning a quick response (QR) code that is displayed on a computer screen; and decoding the QR code to obtain the disambiguation payload.

In Example 24, the subject matter of Examples 19-23 includes, wherein receiving the disambiguation payload comprises receiving the disambiguation payload from an intermediate application through an application-to-application communication mechanism.

In Example 25, the subject matter of Examples 19-24 includes, presenting a confirmation user interface to a user of the mobile device, the confirmation user interface to confirm that the user is to connect with the online web service purportedly associated with the disambiguation payload.

In Example 26, the subject matter of Examples 19-25 includes, presenting a consent user interface to a user of the mobile device, the consent user interface to obtain a selection of identity credential data elements that the user consents to share with the online web service.

In Example 27, the subject matter of Example 26 includes, transmitting the selection of identity credential data elements to the online web service to provide the user's identity to the online web service.

In Example 28, the subject matter of Examples 19-27 includes, wherein the verification data comprises a verification key used to verify the signature associated with the online web service, wherein the key is part of the disambiguation payload.

In Example 29, the subject matter of Examples 19-28 includes, establishing a Transport Layer Security (TLS) session between the application and the online web service; and obtaining a TLS certificate corresponding to the TLS session, wherein the verification data comprises the TLS session key.

In Example 30, the subject matter of Example 29 includes, generating an ephemeral key; and transmitting the ephemeral key to the online web service to establish point-to-point encryption.

In Example 31, the subject matter of Examples 19-30 includes, generating an ephemeral key; and transmitting the ephemeral key to the online web service, the online web service to generate a second disambiguation payload using the ephemeral key; wherein obtaining verification data comprises receiving the second disambiguation payload at the application, and wherein validating the disambiguation payload comprises validating the second disambiguation payload using a corresponding ephemeral key.

Example 32 is at least one machine-readable medium including instructions that, when executed by processing circuitry, cause the processing circuitry to perform operations to implement of any of Examples 1-31.

Example 33 is an apparatus comprising means to implement of any of Examples 1-31.

Example 34 is a system to implement of any of Examples 1-31.

Example 35 is a method to implement of any of Examples 1-31.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A method of using disambiguation data to confirm an association with an online web service prior to engaging in a transaction with an unresolved application executing on a mobile device, comprising:
receiving, at the unresolved application executing on a mobile device, a disambiguation payload, wherein the disambiguation payload is purportedly associated with a web service, and wherein at least a portion of the disambiguation payload is signed with a cryptographic key associated with the web service;
extracting a network location from the disambiguation payload;
obtaining verification data from a resource at the network location to verify the web service; and
validating the disambiguation payload using the verification data.

2. The method of claim 1, wherein the signature is an Elliptic-curve cryptograph (ECC) signature.

3. The method of claim 1, wherein the disambiguation payload is presented by an intermediate application for being consumed by the unresolved application.

4. The method of claim 3 wherein the intermediate application verifies the payload before making it available or presenting it in the document.

5. The method of claim 4, wherein to verify the disambiguation payload, the intermediate application analyzes a signature stored in the disambiguation payload.

6. The method of claim 1, wherein receiving the disambiguation payload comprises:
scanning a quick response (QR) code that is displayed on a computer screen; and
decoding the QR code to obtain the disambiguation payload.

7. The method of claim 1, wherein receiving the disambiguation payload comprises receiving the disambiguation payload from an intermediate application through an application-to-application communication mechanism.

8. The method of claim 1, comprising presenting a confirmation user interface to a user of the mobile device, the confirmation user interface to confirm that the user is to connect with the web service purportedly associated with the disambiguation payload.

9. The method of claim 8, wherein the confirmation user interface is presented after the TLS connection has been initiated and verification data has been received from the web service.

10. The method of claim 1, comprising presenting a consent user interface to a user of the mobile device, the consent user interface to obtain a selection of identity credential data elements that the user consents to share with the web service.

11. The method of claim 10, comprising transmitting the selection of data elements from an identity document to provide the user's identity to the web service.

12. The method of claim 1, wherein the verification data comprises a verification key used to verify the signature associated with the web service, wherein the key is part of the disambiguation payload.

13. The method of claim 1, comprising:
establishing a Transport Layer Security (TLS) session between the unresolved application and the web service; and
obtaining a TLS certificate corresponding to the TLS session,
wherein the verification data comprises the TLS session key.

14. The method of claim 1, comprising:
establishing a Transport Layer Security (TLS) session between the unresolved mobile application and the web service; and
obtaining a TLS certificate corresponding to the TLS session,
wherein the verification data comprising TLS certificate public key.

15. The method of claim 1, comprising:
establishing a Transport Layer Security (TLS) session between the unresolved application and the web service; and
receiving from the web service the verification data.

16. The method of claim 15, comprising:
generating an ephemeral key; and
transmitting the ephemeral key to the web service to establish point-to-point encryption independent from the established TLS transport.

17. The method of claim 1, comprising:
generating an ephemeral key; and
transmitting the ephemeral key to the web service, the web service to generate a second disambiguation payload using the ephemeral key;
wherein obtaining verification data comprises receiving the second disambiguation payload at the mobile identification application, and
wherein validating the disambiguation payload comprises validating the second disambiguation payload using a corresponding ephemeral key.

18. A method of using disambiguation data to confirm an association between an online web service and an unresolved application executing on a mobile device prior to engaging in a transaction using the unresolved application, the method comprising:
receiving, at the unresolved mobile application executing on the mobile device, a disambiguation payload, wherein the disambiguation payload is purportedly associated with the online web service, and wherein at least a portion of the disambiguation payload is signed with a cryptographic key from a trusted party to the unresolved application;
extracting a network location from the disambiguation payload;
confirming the signature with the cryptographic key is valid and from the trusted party;
presenting a prompt using the mobile device for consent to return requested credential data to the network location specified in the disambiguation data; and
returning the requested credential data to the network location in a response to the prompt indicating consent to return the requested credential data.

19. A method of using disambiguation data to confirm an association between an online web service and an application, comprising:
receiving, at the application executing on a mobile device, a disambiguation payload, wherein the disambiguation payload is purportedly associated with the online web service, and wherein a portion of the disambiguation payload is signed with a signature associated with the online web service;
extracting a network location from the disambiguation payload;
obtaining verification data from a resource at the network location; and
validating the disambiguation payload using the verification data.

20. The method of claim 19, comprising:
establishing a Transport Layer Security (TLS) session between the application and the online web service;
obtaining a TLS certificate corresponding to the TLS session,
wherein the verification data comprises the TLS session key;
generating an ephemeral key; and
transmitting the ephemeral key to the online web service to establish point-to-point encryption.
